(19) United States
(12) Patent Application Publication
(10) Pub. No.: US 2018/0274448 A1
(43) Pub. Date: Sep. 27, 2018

(54) SPARK GAP ASSEMBLY WITH NON-RADIOACTIVE GAS FILL

(71) Applicant: Champion Aerospace LLC, Liberty, SC (US)

(72) Inventor: Charles T. FLEETWOOD, Easley, SC (US)

(21) Appl. No.: 15/923,593

(22) Filed: Mar. 16, 2018

Related U.S. Application Data
(60) Provisional application No. 62/475,139, filed on Mar. 22, 2017.

(51) Int. Cl. F02C 7/266; F02P 15/00; H01T 13/05

(52) U.S. Cl. CPC F02C 7/266; F02P 9/00; H01T 13/05; F02P 15/003

(57) ABSTRACT

A spark gap assembly includes a sealed chamber, at least two discharge electrodes, and a non-radioactive gas fill within the sealed chamber. The sealed chamber includes first and second end plugs and a vitreous tube having opposite ends, each end being sealed by one of said end plugs. The discharge electrodes extend through the first and second end plugs, respectively, from an exposed portion outside of the sealed chamber to an enclosed portion inside the sealed chamber. The discharge electrodes each have a discharge portion that includes a surface from which electrons of a spark discharge exit or are received, with the discharge surfaces of the discharge portions facing each other to thereby define a spark discharge gap between the discharge surfaces of the two discharge electrodes. The gas fill within the sealed chamber includes one or more non-radioactive isotopes of one or more noble gases.

### TECHNICAL FIELD

The present invention relates to spark gaps used in ignition exciters for operating igniters in an industrial engines, aircraft ignition systems, and other applications involving combustible gases.

### BACKGROUND

Spark gaps, also referred to herein as spark gap assemblies, are typically discrete components used in exciter circuits and the like to assist in the consistent delivery of spark energy to an igniter used in an aircraft or other turbine engine. U.S. Pat. No. 7,130,180 discloses an exemplary exciter having a discharge circuit that includes a switching device in the form of a spark gap. Other types of exciter circuits that incorporate a spark gap, and other applications of such spark gaps are known.

Spark gaps in use today include a sealed chamber containing two discharge electrodes and a radioactive gas fill that utilizes a radioisotope such as tritium (³H) or Krypton-85(⁸⁵Kr). The radioisotope ionizes the gas within the sealed chamber and helps maintain a consistent ionization level to thereby help provide a consistent delivery of spark discharge energy to the igniter.

### SUMMARY

In accordance with an aspect of the invention, there is provided a spark gap assembly, comprising a sealed chamber, at least two discharge electrodes located in the sealed chamber, and a non-radioactive noble gas fill within the sealed chamber.

Various embodiments of the spark gap assembly may include any of the following features or any technically-feasible combination of two or more of the following features”
the gas fill contains only non-radioactive isotopes of one or more noble gases with no more than trace amounts of any other gas;
the gas fill contains a plurality of noble gases;
the discharge electrodes comprise first and second electrodes separated from each other by a spark discharge gap that is exposed to the gas fill;
the spark gap assembly includes a third electrode located in the sealed chamber in a position to facilitate a spark discharge across the discharge gap;
the gas fill and spark discharge gap are configured to provide a spark discharge across the discharge gap at one or more voltages between 1,000 and 10,000 volts;
the spark gap assembly accommodates a particular amount of spark energy in the range of 0.1 to 20 joules;
the sealed chamber includes first and second end plugs and a vitreous tube having opposite ends, each said end being sealed by one of said end plugs; and wherein the discharge electrodes comprise first and second electrodes extending through the first and second end plugs, respectively, from an exposed portion outside of the sealed chamber to an enclosed portion inside the sealed chamber; and/or
the vitreous tube comprises a material made of glass or ceramic.

In accordance with another aspect of the invention, there is provided a spark gap assembly, comprising: a sealed chamber that includes first and second end plugs and a vitreous tube having opposite ends, each said end being sealed by one of said end plugs; at least two discharge electrodes comprising first and second discharge electrodes extending through the first and second end plugs, respectively, from an exposed portion outside of the sealed chamber to an enclosed portion inside the sealed chamber, the first and second discharge electrodes each having a discharge portion that includes a surface from which electrons of a spark discharge exit or are received, wherein the discharge surfaces of the discharge portions face each other to thereby define a spark discharge gap between the discharge surfaces of the first and second discharge electrodes; and a non-radioactive gas fill within the sealed chamber that includes one or more non-radioactive isotopes of one or more noble gases. The gas fill and spark discharge gap are configured to provide a spark discharge across the discharge gap at one or more voltages between 1,000 and 10,000 volts, and the spark gap assembly accommodates a particular amount of spark energy in the range of 0.1 to 20 joules.

### BRIEF DESCRIPTION OF THE DRAWINGS

One or more embodiments of the invention will hereinafter be described in conjunction with the appended drawings, wherein like designations denote like elements, and wherein:

FIG. 1 depicts a first embodiment of a spark gap assembly constructed in accordance with the invention; and

FIG. 2 depicts a second embodiment of a spark gap assembly constructed in accordance with the invention.

### DETAILED DESCRIPTION

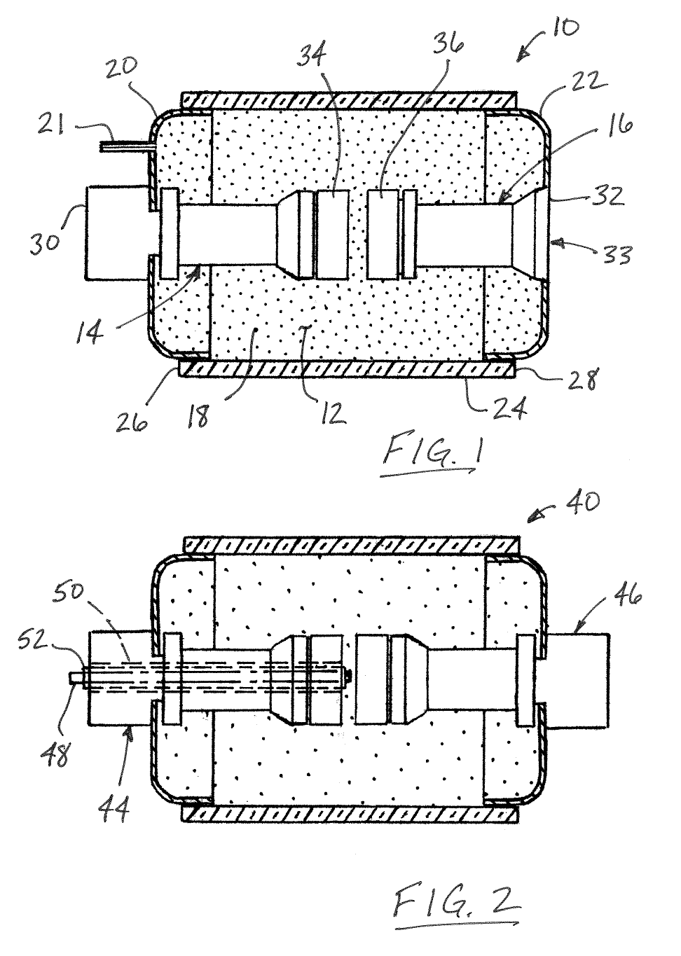

With reference to FIG. 1, there is shown a spark gas assembly 10 that includes a sealed chamber 12, first and second discharge electrodes 14, 16 located in the sealed chamber 12, and a non-radioactive noble gas fill 18 within the chamber 12. The sealed chamber 12 includes first and second end plugs 20, 22 and a vitreous hollow cylindrical tube 24 having opposite ends 26, 28 which are sealed by one of the end plugs 20, 22, respectively. The first and second discharge electrodes 14, 16 extend through the first and second end plugs 20, 22, respectively, from an exposed portion outside of the sealed chamber to an enclosed portion inside the sealed chamber.

The vitreous tube 24 may be made from glass, ceramic, or other suitable material. Suitable materials and commercially-available glass and ceramic tubing are available and will be known to those skilled in the art.

The end plugs 20, 22 may each be made of suitable materials epoxied or otherwise bonded to the tube 24. For example, the end plugs 20, 22 may each be made of a dielectric material or of a conductive material that is either electrically connected to their respective electrodes 14, 16, or insulated therefrom using a separate dielectric component (not shown). In the illustrated embodiment, end plug 20 includes a fill tube 21 for the evacuation of fluids from the sealed chamber 12 and for the subsequent fill of chamber 12 with the noble gas or gases 18. In other embodiments the evacuation and filling of the sealed chamber 12 may be done in other ways, as will be known by those skilled in the art.

The discharge electrodes 14, 16 may be constructed the same as each other (as shown in FIG. 2) or as different electrodes, as shown in FIG. 1; for example, one electrode 14 may include an exterior post 30 at its exposed portion, while the other electrode 16 may include a contact surface 32 presented at the face of its associated end plug 22 or may include a recess 33 that may be threaded for receiving a threaded terminal connector (not shown) when being assembled in circuit in an exciter or other application. The electrodes 14, 16 may be unitary components fitted into their respective end plugs 20, 22, or may each be made of a plurality of parts connected together. The electrodes 14, 16 include a discharge portion 34, 36, respectively, that presents a tip or surface from which electrons of a spark discharge exit or are received. The discharge portions 34, 36 may be made of tungsten or alloys thereof, or any other suitable platinum group or other metal. The electrodes 14, 16 are mounted in the end plugs 20, 22, respectively so as to position their respective discharge portions facing each other to thereby define a spark discharge gap between the discharge surfaces of the two electrodes.

The non-radioactive noble gas fill may contain a single noble gas or a combination of noble gases. As used herein, noble gases are those naturally-occurring elements occupying Group 18 of the periodic table; namely, Helium, Neon, Argon, Krypton, Xenon, and Radon. In at least some embodiments, the non-radioactive noble gas fill 18 contains only non-radioactive isotopes of one or more noble gases with no more than trace amounts of any other gas. And in some embodiments, the noble gas fill 18 comprises non-radioactive isotopes of one or more noble gases selected from the group of noble gases consisting of Neon, Argon, Krypton, Xenon, and Radon. The noble gases have high ionization energies relative to their neighboring elements and may be used to provide a consistent DC spark discharge voltage across the electrodes 14, 16. In other embodiments, other non-noble gases may be included with the non-radioactive isotopes of the noble gas(es), such as nitrogen and oxygen and, in such cases, the noble gas(es) may comprise any of a number of different amounts of the total gas fill 18; for example 1-10% of the total gas fill.

As will be appreciated by those skilled in the art, the particular spark discharge voltage of the spark gap assembly 10 depends on a number of parameters and can be set by a suitable combination of spark discharge gap spacing, noble gas fill 18 mix and pressure, as well as other features such as the geometry of the discharge surfaces of the electrodes (e.g., sharp, or wide and flat) and the particular material of which the discharge surface is made. In some embodiments, these features are set such that the spark discharge voltage is within the range of 1,000 and 10,000 volts. For example, the gas fill and spark discharge gap may be configured to provide a spark discharge across the discharge gap at one or more voltages between 1,000 and 10,000 volts; for example, at 4,000 volts. The spark gap assembly 10 may also be designed to accommodate a particular amount or range of spark energy, such as 0.1 to 20 joules.

FIG. 2 depicts a second embodiment 40 of a spark gap assembly of the invention. The design and construction of the spark gap 40 may be as described above in connection with FIG. 1, except that as shown, it (i) has two discharge electrodes 44, 46 that each include a post on the exterior exposed portion of the electrode, (ii) includes a third spark assist electrode 48, (iii) has a lower pressure gas fill, and (iv) does not include any fill tube. The third electrode 48 may be located coaxially with one of the electrodes, such as in a central bore 50 of electrode 44, with an insulator 52 separating the spark assist electrode 48 from the electrode 44. By suitable application of high voltage across the spark discharge gap formed between the electrodes 44, 46 along with use of a spark triggering voltage pulse on the electrode 48, precise timing of the spark discharge may be obtained.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A spark gap assembly, comprising:
a sealed chamber;
at least two discharge electrodes located in the sealed chamber; and
a non-radioactive noble gas fill within the sealed chamber.

2. The spark gap assembly defined in claim 1, wherein the gas fill contains only non-radioactive isotopes of one or more noble gases with no more than trace amounts of any other gas.

3. The spark gap assembly defined in claim 1, wherein the gas fill contains a plurality of noble gases.

4. The spark gap assembly defined in claim 1, wherein the discharge electrodes comprise first and second electrodes separated from each other by a spark discharge gap that is exposed to the gas fill.

5. The spark gap assembly defined in claim 4, further comprising a third electrode located in the sealed chamber in a position to facilitate a spark discharge across the discharge gap.

6. The spark gap assembly defined in claim 4, wherein the gas fill and spark discharge gap are configured to provide a spark discharge across the discharge gap at one or more voltages between 1,000 and 10,000 volts.

7. The spark gap assembly defined in claim 4, wherein the spark gap assembly accommodates a particular amount of spark energy in the range of 0.1 to 20 joules.

8. The spark gap assembly defined in claim 1, wherein the sealed chamber includes first and second end plugs and a vitreous tube having opposite ends, each said end being sealed by one of said end plugs; and wherein the discharge electrodes comprise first and second electrodes extending through the first and second end plugs, respectively, from an exposed portion outside of the sealed chamber to an enclosed portion inside the sealed chamber.

9. The spark gap assembly defined in claim 8, wherein the vitreous tube comprises a material made of glass or ceramic.

10. A spark gap assembly, comprising:
a sealed chamber that includes first and second end plugs and a vitreous tube having opposite ends, each said end being sealed by one of said end plugs;
at least two discharge electrodes comprising first and second discharge electrodes extending through the first and second end plugs, respectively, from an exposed portion outside of the sealed chamber to an enclosed portion inside the sealed chamber, the first and second discharge electrodes each having a discharge portion that includes a surface from which electrons of a spark discharge exit or are received, wherein the discharge surfaces of the discharge portions face each other to thereby define a spark discharge gap between the discharge surfaces of the first and second discharge electrodes; and
a non-radioactive gas fill within the sealed chamber that includes one or more non-radioactive isotopes of one or more noble gases;
wherein the gas fill and spark discharge gap are configured to provide a spark discharge across the discharge gap at one or more voltages between 1,000 and 10,000 volts and wherein the spark gap assembly accommodates a particular amount of spark energy in the range of 0.1 to 20 joules.
